(19) United States
(12) Patent Application Publication
(10) Pub. No.: US 2025/0271981 A1
(43) Pub. Date: Aug. 28, 2025

(54) METHOD, APPARATUS, DEVICE, AND STORAGE MEDIUM FOR MEDIA ITEM INPUT

(71) Applicant: Beijing Zitiao Network Technology Co., Ltd., Beijing (CN)

(72) Inventors: Xu Liu, Beijing (CN); Xinyu Zhang, Beijing (CN)

(21) Appl. No.: 19/060,607

(22) Filed: Feb. 21, 2025

(30) Foreign Application Priority Data
Feb. 23, 2024 (CN) 202410202949.3

(51) Int. Cl. G06F 3/0484; G06F 3/0482

(52) U.S. Cl. CPC G06F 3/0484; G06F 3/0482

(57) ABSTRACT

The embodiments of the disclosure relates to a method, apparatus, device, and storage medium for media item input. The method provided here includes: presenting a plurality of media items based on input information of a user, and the plurality of media items are determined based on the input information; adding a first media item in a media editing window in response to a selection of the first media item of the plurality of media items; and in response to at least one predetermined operation for the first media item, replacing the first media item in the media editing window with a second media item of the plurality of media items. In this way, the embodiments of the disclosure may efficiently switch different media items for editing, thereby improving efficiency of media editing.

### CROSS-REFERENCE

This application claims the priority of Chinese Patent Application No. 202410202949.3, filed on Feb. 23, 2024, entitled “METHOD, APPARATUS, DEVICE AND STORAGE MEDIUM FOR MEDIA ITEM INPUT,” the entire content of which is incorporated herein by reference.

### FIELD

Example embodiments of the present disclosure generally relate to the field of computers, and in particular, to a method, apparatus, device, and computer-readable storage medium for media item input.

### BACKGROUND

With the development of computer technology, the Internet has become an important platform for people to create and share content. In the process of sharing the content created by people through the Internet, various media items (e.g., stickers, etc.) have become the personalized expression of people in sharing photos, videos, and other content items. People expect to use more unique and diversified media items in the process of content creation.

### SUMMARY

In a first aspect of the present disclosure, a method of inputting a media item is provided. The method includes: presenting a plurality of media items based on input information of a user, and the plurality of media items are determined based on the input information; adding a first media item in a media editing window in response to a selection of the first media item of the plurality of media items; and in response to at least one predetermined operation for the first media item, replacing the first media item in the media editing window with a second media item of the plurality of media items.

In a second aspect of the present disclosure, an apparats for media item input is provided. The apparatus includes: a presenting module configured to present a plurality of media items based on input information of a user, and the plurality of media items are determined based on the input information; an adding module configured to add a first media item in a media editing window in response to a selection of the first media item of the plurality of media items; and a replacing module configured to replace, in response to at least one predetermined operation for the first media item, replace the first media item in the media editing window with a second media item of the plurality of media items.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer-readable storage medium having a computer program stored thereon is provided. The computer program being executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A to 2B illustrate example interfaces according to some embodiments of the present disclosure;

FIGS. 3A to 3C illustrate example interfaces according to some embodiments of the present disclosure;

FIG. 4 illustrates an example interface according to some embodiments of the present disclosure;

FIG. 5 illustrates a flowchart of an example process of media item input according to some embodiments of the present disclosure;

FIG. 6 illustrates a schematic structural block diagram of an example apparatus for media item input according to some embodiments of the present disclosure; and

FIG. 7 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like should be understood to include ‘including but not limited to’. The term ‘based on’ should be understood as ‘based at least in part on’. The terms ‘one embodiment’ or ‘the embodiment’ should be understood as ‘at least one embodiment’. The term ‘some embodiments’ should be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the schemes in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

In a process of creating and sharing content through the Internet, media items such as stickers are important elements used by people to create and process content items. However, in the traditional content creation process, the user needs to perform a cumbersome operation in the process of adding and replacing a media item, which greatly increases the editing cost of the user.

The embodiment of the disclosure provides a scheme of inputting a media item. According to the scheme, a plurality of media items are presented based on input information of a user, and the plurality of media items are determined based on the input information. Further, the first media item may be added in a media editing window in response to a selection of a first media item of the plurality of media items. Further, in response to at least one predetermined operation for the first media item, the first media item in the media editing window is replaced with a second media item of the plurality of media items.

In this way, the embodiments of the present disclosure may efficiently switch different media items for editing, thereby improving efficiency of media editing.

Various example implementations of this scheme are described in detail below in conjunction with the accompanying drawings.

### Example Environment

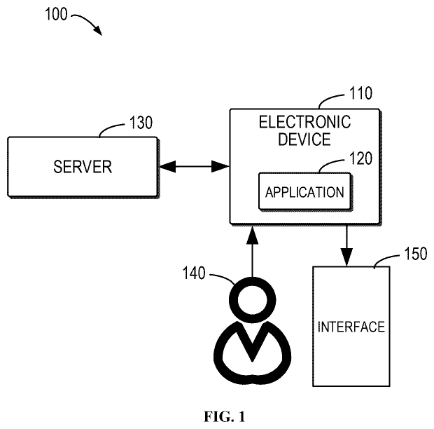

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or a further suitable application. A user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a ‘wearable’ circuit, etc.).

The server 130 may be a standalone physical server, a server cluster composed of a plurality of physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support virtual scenarios in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like. The embodiments of the present disclosure are not limited in this aspect. In the embodiments of the present disclosure, the server 130 and the electronic device 110 may implement signaling interaction through a communication connection between the server 130 and the electronic device 110.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

An example interaction process according to embodiments of the present disclosure will be described below with reference to the accompanying drawings.

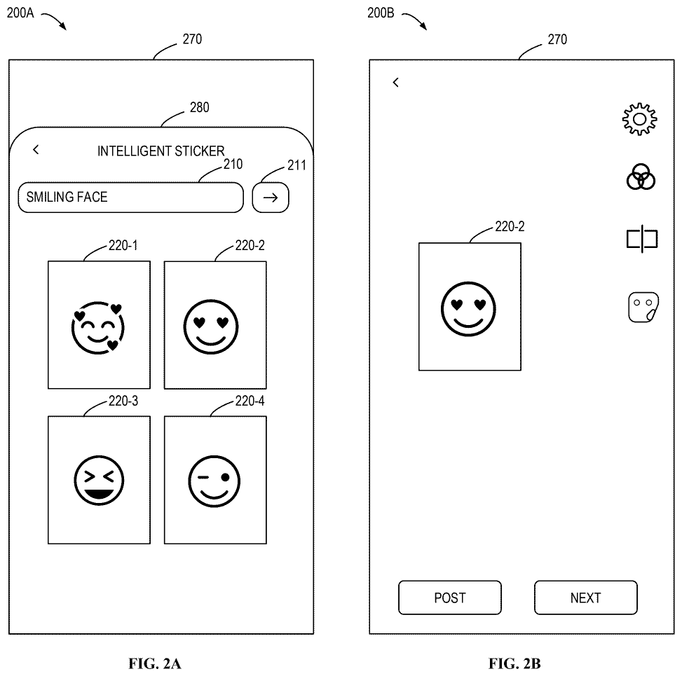

FIGS. 2A to 2B illustrate example interfaces 200A to 200B according to some embodiments of the present disclosure. The interfaces 200A to 200B may be provided by the electronic device 110 shown in FIG. 1.

As an example, the interface 200A may be a media editing interface for editing a media content. The electronic device 110 may present a panel 280 in the interface 200A based on a request of the user to add a media item.

It should be understood that FIG. 2A takes a sticker as an example of a media item, but the media item may further include a further media item with a visual content, including but not limited to a static picture, a dynamic picture, an artistic word, an emoticon item, and the like.

As shown in FIG. 2A, after receiving a predetermined operation of the user, the electronic device 110 may invoke the panel 280 in the interface 200A. As shown in FIG. 2A, in the panel 280, the electronic device 110 may provide an input control 210. The input control 210 may be any suitable type of control for inputting information, for example.

The input control 210 may receive input information input by a user. The input information may be a description of a sticker that the user desires to add on the media content item. The input information may include a noun representing a person or an object, a verb representing a person or an object related action, an adjective, and the like. The input information may be, for example, ‘a cat is drinking’, ‘a lovely dog’, ‘a little girl twirling in a dress’, etc., to meet a personalized creation of the user for the media content item.

The following specific embodiments further describe example processes of the present disclosure with examples in which the input information is ‘smiling face’.

As shown in FIG. 2A, in the panel 280, the electronic device 110 receives input information of a user input, for example, a text ‘smiling face’, in the input control 210. Further, the electronic device 110 may, for example, receive a click of the user on a control 211, and correspondingly provide a plurality of stickers determined based on the input information, including a sticker 220-1, a sticker 220-2, a sticker 220-3, and a sticker 220-4 (individually or collectively referred to as the sticker 220).

In some embodiments, the sticker 220 may be determined by the electronic device 110 and/or the server 130 based on input information (e.g., ‘smiling face’). As an example, the electronic device 110 may search a local sticker item or a cloud sticker item matching the input information based on the input information and present a search result in the panel 280.

In some further embodiments, the media item (e.g., the sticker 220) may also be generated with a model. Specifically, the electronic device 110 and/or the server 130 may generate a prompt to the model based on the input information and may provide the prompt to the model. Further, the electronic device 110 and/or the server 130 may obtain a media item, for example, the sticker 220, generated by the model based on the prompt.

In some embodiments, the sticker 220 may further include both a sticker searched and generated based on the input information.

In some embodiments, the number of generated stickers displayed on the panel 280 may be limited to within a predetermined threshold. For example, the number of stickers displayed on the panel 280 may be set to 4.

As shown in FIG. 2B, the electronic device 110 may receive a selection instruction of the sticker 220-2 by the user. Further, the electronic device 110 may add the selected sticker 220-2 to a media editing window 270. For example, the electronic device 110 may add the sticker 220-2 to a user-specified location. As an example, the media editing window 270 of the electronic device 110 may display a media content item added with the sticker 220-2 to present a preview content of the media content item to be edited.

In some embodiments, the electronic device 110 may further support adding a plurality of media items to the media editing window 270. For example, the electronic device 110 may support the user to input new information to obtain a sticker or a further type of media item and may add a corresponding media item to the media editing window 270.

As still a further example, the electronic device 110 may also support, for example, the user selecting a plurality of stickers from the stickers 220 provided by the panel 280 at a time to add to the media editing window 270.

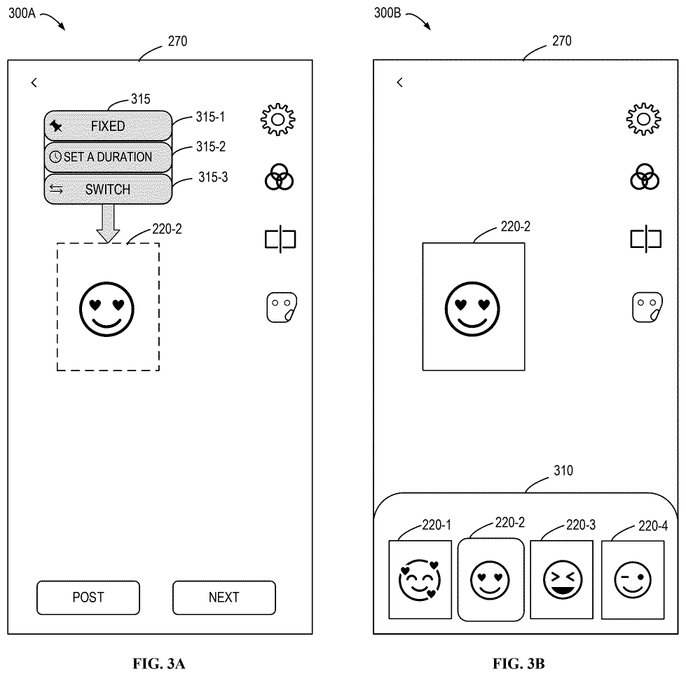

Example interaction processes will be described further below with reference to FIGS. 3A to 3C. FIGS. 3A to 3C illustrate example interfaces 300A to 300C according to some embodiments of the present disclosure. The interfaces 300A to 300C may be provided by the electronic device 110 shown in FIG. 1. Both the interface 300A to the interface 300C have displayed a media content item (the specific content of the media content item is not shown in the figure), the media content item covers the entire interface and is in an editing state.

As shown in FIG. 3A, in the media editing window 270, the electronic device 110 may receive a user selection instruction for the added sticker 220-2. In response to the selection of the added sticker 220-2, the electronic device 110 may display a setting panel 315. The settings panel 315 includes a replacement entry 315-3 through which the replacement entry 315-3 may enter a selection panel 310 to replace the sticker 220-2.

In some embodiments, the settings panel 315 further includes other interaction entries. For example, the settings panel 315 may further include a fixed entry 315-1 and a duration setting entry 315-2. The fixed entry 315-1 and the duration setting entry 315-2 may be configured to edit a further item of the media content item to which a sticker is added.

As shown in FIG. 3A, the electronic device 110 may display the replacement entry 315-3 through an icon, which displays a ‘switch’ typeface to guide the user to use the entry for sticker replacement.

In addition, since a plurality of media items may be added to the media content item, the electronic device 110 may highlight the added media item by selecting the added media item to invoke the settings panel 315 in the media editing window 270. For example, assuming that the sticker 220-1 and the sticker 220-2 are added at the same time on the media content item of the media editing window 270, when the sticker 220-2 is selected to evoke the settings panel 315, a dashed frame as shown in FIG. 3A can be added to the sticker 220-2 to indicate that it is in a selected state. For highlighting of the selected state, as long as further stickers (such as the sticker 220-1) added on the current media content item may be clearly distinguished.

As shown in FIG. 3B, in response to receiving a selection of replacement entry 315-3, the electronic device 110 may display the selection panel 310. As an example, the selection panel 310 may be provided at the bottom of the media editing window 270, for example. In a further embodiment, the position of the selection panel 310 may also be set at any suitable position such as a side of the media editing window 270.

In some embodiments, the selection panel 310 may be configured to display at least some of the plurality of media items provided by the display panel 280 based on the input information, to support the user to quickly switch to a further media item corresponding to the input information.

As an example, as shown in FIG. 3B, the selection panel 310 of the electronic device 110 may display some or all of the plurality of stickers 220 provided in the panel 280. Specifically, the number of the stickers 220 displayed by the selection panel 310 may be determined based on a display size of the selection panel 310. For example, in a case that the number of stickers 220 provided by the panel 280 is relatively large, the electronic device 110 may support the user by sliding in the selection panel 310 to view a further unpresented sticker.

In an example embodiment, as shown in FIG. 3B, the selection panel 310 may, for example, highlight the selected sticker 220-2 to be replaced. For example, the sticker 220-2 may have a different color style, frame style, etc. than the other stickers 220.

Further, the electronic device 110 may receive a selection instruction for the user for a further sticker in the selection panel 310 to replace the sticker 220-2 that has been added to the media editing window 270. As shown in FIG. 3C, the electronic device 110 receives a selection instruction for the user on the sticker 220-3 in the selection panel 310 and replaces the original sticker 220-2 with the sticker 220-3.

In some embodiments, the position of the replaced sticker 220-3 may remain the same as the position of the original sticker 220-2. Alternatively, the electronic device 110 may receive a position change of the user on the replaced sticker 220-3.

Further, when the electronic device 110 receives the selection instruction for the user on the sticker 220-3 in the selection panel 310 to replace the original sticker 220-2, the electronic device 110 may be switched to highlight the sticker 220-3 in the selection panel 310.

In a further embodiment, the selection panel 310 may display only part of the stickers 220 corresponding to the input information each time. For example, when the electronic device 110 receives an invocation from the user on the selection panel 310, the selection panel 310 may display only the sticker 220-2 to be replaced.

In some embodiments, the electronic device 110 may correspondingly display different stickers by receiving left and right sliding of the user on the selection panel 310. For example, in the case that the sticker 220-2 is currently displayed, the electronic device 110 may receive a leftward swipe of the user on the selection panel 310 to display the next sticker 220-3. The electronic device 110 may also receive a rightward swipe of the user on the selection panel 310 to display the previous sticker 220-1. In this case, a single sticker displayed each time the selection panel 310 is displayed is the sticker to be replaced. For example, the electronic device 110 may receive a click of the user on the sticker 220-3 displayed on the selection panel 310, thereby replacing the sticker 220-2 originally added in the media editing window 270 with the sticker 220-3.

In yet a further embodiment, the selection panel 310 supports the user sliding upward from the bottom to show more stickers.

Example interactions of switching stickers are described above in connection with the panel 310. In some embodiments, for example, the electronic device 110 may also support the user to quickly switch the added stickers based on a further appropriate interaction operation. As an example, when the sticker 220-2 is in a selected state, the electronic device 110 may, for example, replace the sticker 220-2 with a further sticker in the plurality of stickers provided by the panel 280 based on a sliding operation of the user in a predetermined area.

Alternatively, the electronic device 110 may further provide a control such as ‘replace with the next’ or ‘replace with the previous’ to support the user in quickly replacing the sticker with yet a further one of the plurality of stickers.

An example interaction process for media item replacement is described above for the sticker 220-2 as an example. In some embodiments, when other added media items are included in the media editing window, such media items may also, for example, support replacement by way of such interaction.

As an example, the electronic device 110 may support the user obtaining a corresponding set of expression items by describing text and may add a first expression item in the expression item to the media editing window. Further, the electronic device 110 may, for example, support the user triggering the replacement for the first expression item based on the above similar interaction process, and replacing it with a further expression item in the set of expression items corresponding to the description text.

Based on this manner, the embodiments of the present disclosure may avoid the user from re-searching/generating the corresponding media item, thereby improving the efficiency of adding and editing the media item by the media item.

In some embodiments, a sticker added on the media content item is a used sticker, and the electronic device 110 stores the used sticker locally. For example, even if a media content item has not yet been posted, or the media content item has been discarded, any sticker that has been added to the media content item is a used sticker. The electronic device 110 may store the used sticker in a local predetermined sticker library, so that the user may directly search from the sticker library when the user wants to use again. This effectively improves the efficiency of the search for reused stickers by the user.

In a further embodiment, all generated stickers displayed on the panel 280 are added to a historical generation record for the user to directly search for the generated stickers to use, thereby avoiding regeneration, thereby saving the search time of the user.

In some embodiments, the historical generation record may be a sticker generated in a reverse order based on the generation time.

In some embodiments, the electronic device 110 may also receive a request for the user to post the media content item and post the media content item accordingly. For example, the posted media content item may include media items added via the processes described above, or alternative media items.

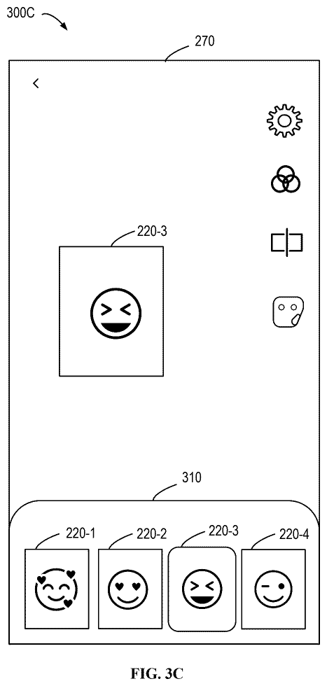

FIG. 4 illustrates an example interface 400 according to some embodiments of the present disclosure. The interface 400 may be, for example, a viewing interface of a posted media content item 410. The interface 400 may be provided by the appropriate electronic device 110, which may be the same as or different from the electronic device 110 used to edit and post the media content item 410.

As shown in FIG. 4, the media content item 410 includes a sticker 420 added based on user input information. In some embodiments, when the sticker 420 is generated based on the input information with the model, the electronic device 110 may further present an indication element 430 in association with the sticker 420 in the viewing interface 400 of the media content item 410, to indicate that the sticker 420 process a sticker generated by the input information of the user with the model.

In some embodiments, the indication element 430 may be configured to be direct to an item generation panel, the item generation panel being configured to provide a media item generated based on received input information. For example, when a browsing user of the media content item 410 is viewing the interface 400, a corresponding client may present an item generation panel based on a selection instruction from the viewing user to the indication element 430. This item generation panel may, for example, refer to the description with respect to the panel 280 shown in FIG. 2A.

Specifically, the item generation panel may be configured to present the media item generated based on the received input information, to facilitate the user to add to the media content item.

It should be understood that although the example interaction process is described above by using a sticker as an example, the above interaction process may be applicable to any other suitable media items, for example, a static picture, a dynamic picture, an artistic word, an emoticon item, or the like.

Based on the above process, the embodiments of the present disclosure may efficiently switch different media items corresponding to the same input information for editing in the editing process of the media content item, thereby improving efficiency of media editing.

### Example Process

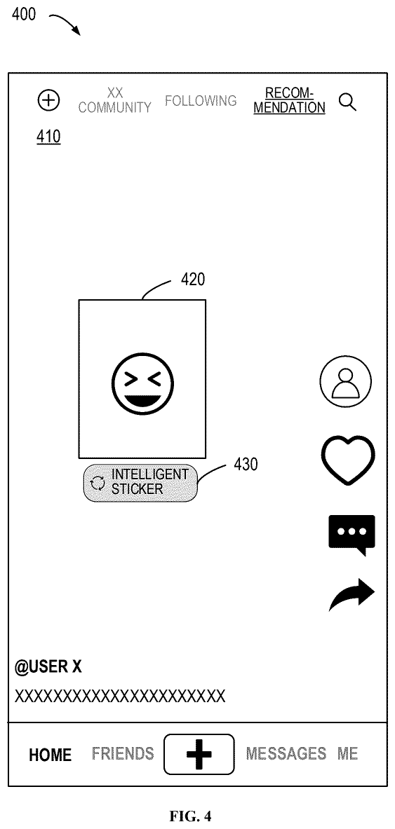

FIG. 5 illustrates a flowchart of an example process 500 of media item input according to some embodiments of the present disclosure. The process 500 may be implemented at the electronic device 110. The process 500 is described below with reference to FIG. 1.

As shown, at block 510, the electronic device 110 presents a plurality of media items based on input information of a user, and the plurality of media items are determined based on the input information.

At block 520, the electronic device 110 adds a first media item in a media editing window in response to a selection of the first media item of the plurality of media items.

At block 530, in response to at least one predetermined operation for the first media item, the first media item in the media editing window is replaced with a second media item of the plurality of media items.

In some embodiments, in response to at least one predetermined operation for the first media item, replacing the first media item in the media editing window with the second media item of the plurality of media items includes: in response to triggering the first media item, presenting at least one further media item of the plurality of media items; and in response to a selection of the second media item of the at least one further media item, replacing the first media item in the media editing window with the second media item.

In some embodiments, presenting the at least one further media item of the plurality of media items includes: presenting a replacement entry in response to triggering the first media item; and in response to a selection of the replacement entry, presenting the at least one further media item of the plurality of media items.

In some embodiments, presenting the at least one further media item of the plurality of media items further includes: presenting the plurality of media items in a selection panel, wherein the first media item is highlighted in the selection panel.

In some embodiments, adding the first media item in the media editing window includes: in response to a selection of the first media item and at least one third media item of the plurality of media items, adding the first media item and the at least one third media item to the media editing window.

In some embodiments, the input information is the first input information, and the process 500 further includes: displaying an added fourth media item in the media editing window, and the fourth media item is determined based on second input information, the second input information being different from the first input information; and in response to a selection of the fourth media item, replacing the fourth media item with a fifth media item corresponding to the second input information.

In some embodiments, the process 500 further includes: posting a media content item including the replaced second media item.

In some embodiments, the plurality of media items are generated by a model based on the input information. In some embodiments, a playback interface of the media content item is configured to present an indication element in association with the second media item, the indication element indicating that the second media item is generated by the model.

In some embodiments, the indication element is configured to direct to an item generation panel, and the item generation panel is configured to provide a media item generated based on received input information.

### Example Apparatus and Device

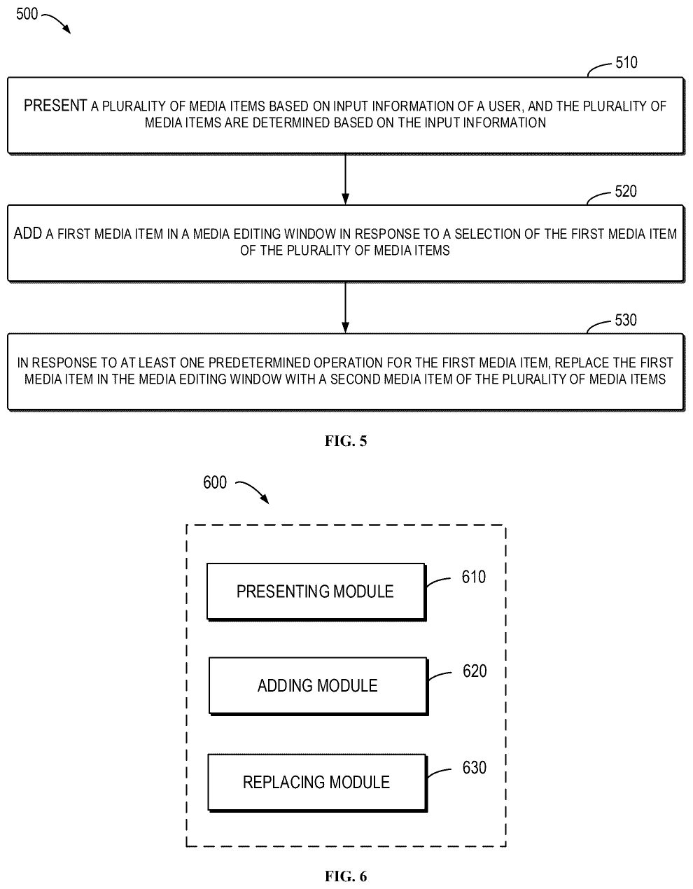

Embodiments of the present disclosure also provide a corresponding apparatus for implementing the above method or process. FIG. 6 shows a schematic structural block diagram of an example apparatus 600 for media item input according to some embodiments of the present disclosure. The apparatus 600 may be implemented or included in the electronic device 110. The various modules/components in the apparatus 600 may be implemented by hardware, software, firmware, or any combination thereof.

As shown in FIG. 6, the apparatus 600 includes a presenting module 610 configured to present a plurality of media items based on input information of a user, and the plurality of media items are determined based on the input information; an adding module 620 configured to add a first media item in a media editing window in response to a selection of the first media item of the plurality of media items; and a replacing module 630 configured to replace, in response to at least one predetermined operation for the first media item, the first media item in the media editing window with a second media item of the plurality of media items.

In some embodiments, the replacement module 630 is configured to: in response to triggering the first media item, present at least one further media item of the plurality of media items; and in response to a selection of the second media item of the at least one further media item, replace the first media item in the media editing window with the second media item.

In some embodiments, the replacement module 630 includes a replacement entry presenting module configured to: present a replacement entry in response to triggering the first media item; and in response to a selection of the replacement entry, present the at least one further media item of the plurality of media items.

In some embodiments, the replacement entry presenting module is further configured to: present the plurality of media items in a selection panel, wherein the first media item is highlighted in the selection panel.

In some embodiments, the adding module 620 is further configured to: in response to a selection of the first media item and at least one third media item of the plurality of media items, add the first media item and the at least one third media item to the media editing window.

In some embodiments, the input information is the first input information, and the apparatus 600 further includes an adding module configured to: display an added fourth media item in the media editing window, and the fourth media item is determined based on second input information, the second input information being different from the first input information; and in response to a selection of the fourth media item, replacing the fourth media item with a fifth media item corresponding to the second input information.

In some embodiments, the apparatus 600 further includes a posting module configured to post a media content item including the replaced second media item.

In some embodiments, the plurality of media items are generated by a model based on the input information. In some embodiments, a playback interface of the media content item is configured to present an indication element in association with the second media item, the indication element indicating that the second media item is generated by the model.

In some embodiments, the indication element is configured to direct to an item generation panel, and the item generation panel is configured to provide a media item generated based on received input information.

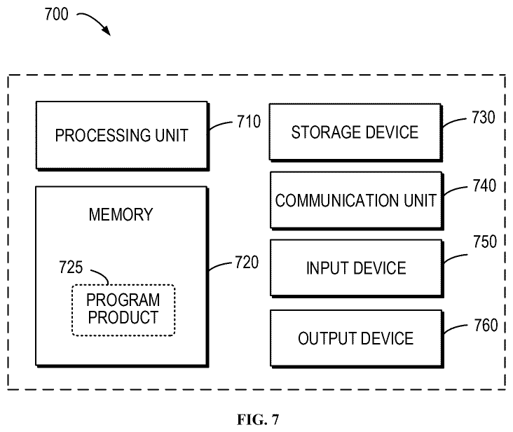

FIG. 7 illustrates a block diagram of an electronic device 700 in which one or more embodiments of the present disclosure may be implemented. It should be understood that the electronic device 700 illustrated in FIG. 7 is merely for example and should not constitute any limitation on the function and scope of the embodiments described herein. The electronic device 700 illustrated in FIG. 7 may be configured to implement the electronic device 110 of FIG. 1.

As shown in FIG. 7, the electronic device 700 is in a form of a general-purpose electronic device. Components of the electronic device 700 may include, but are not limited to, one or more processors or processing units 710, memory 720, storage device 730, one or more communication units 740, one or more input devices 750, and one or more output devices 760. The processing units 710 may be actual or virtual processors and are capable of performing various processes based on programs stored in the memory 720. In a multiprocessor system, a plurality of processing units perform computer-executable instructions in parallel to increase the parallel processing power of the electronic device 700.

The electronic device 700 typically includes a plurality of computer storage media. Such media may be any obtainable media accessible to the electronic device 700, including, but not limited to, volatile and non-volatile media, removable and non-removable media. The memory 720 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, a disk, or any other medium that may be capable of being configured to store information and/or data and may be accessible within the electronic device 700.

The electronic device 700 may further include additional removable/non-removable, volatile/non-volatile storage media. Although not shown in FIG. 7, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 720 may include a computer program product 725 having one or more program modules that are configured to perform various methods or actions of various embodiments of the present disclosure.

The communication unit 740 implements communication with other electronic devices via a communication medium. Additionally, the functions of the components of the electronic device 700 may be implemented as a single computing cluster or a plurality of computing machines that are capable of communicating over a communication connection. Thus, the electronic device 700 may use logical connections to one or more other servers, networked personal computers (PCs), or another network node to operate in a networked environment.

The input device 750 may be one or more input devices, such as a mouse, a keyboard, a tracking ball, and the like. The output device 760 may be one or more output devices, such as a monitor, a speaker, a printer, and the like. The electronic device 700 may also communicate, as desired, via the communication unit 740, with one or more external devices (not shown), external devices such as storage devices, display devices, etc., with one or more devices that enable a user to interact with the electronic device 700, or with any device that enables the electronic device 700 to communicate with one or more other electronic devices (e.g., a network card, modem, etc.) to communicate. Such communication may be performed via an input/output (I/O) interface (not shown).

According to an example implementation of the present disclosure, there is provided a computer-readable storage medium having computer-executable instructions stored thereon, wherein the computer-executable instructions are performed by a processor to implement the method described above. According to an example implementation of the present disclosure, there is also provided a computer program product, the computer program product being tangibly stored on a non-transient computer-readable medium and including computer-executable instructions, wherein the computer-executable instructions are performed by a processor to implement the methods described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of inputting a media item, comprising:
presenting a plurality of media items based on input information of a user, and the plurality of media items are determined based on the input information;
adding a first media item in a media editing window in response to a selection of the first media item of the plurality of media items; and
in response to at least one predetermined operation for the first media item, replacing the first media item in the media editing window with a second media item of the plurality of media items.

2. The method of claim 1, wherein in response to at least one predetermined operation for the first media item, replacing the first media item in the media editing window with the second media item of the plurality of media items comprises:
in response to triggering the first media item, presenting at least one further media item of the plurality of media items; and
in response to a selection of the second media item of the at least one further media item, replacing the first media item in the media editing window with the second media item.

3. The method of claim 2, wherein presenting the at least one further media item of the plurality of media items comprises:
presenting a replacement entry in response to the triggering of the first media item; and
in response to a selection of the replacement entry, presenting the at least one further media item of the plurality of media items.

4. The method of claim 2, wherein presenting the at least one further media item of the plurality of media items further comprises:
presenting the plurality of media items in a selection panel, wherein the first media item is highlighted in the selection panel.

5. The method of claim 1, wherein adding the first media item in the media editing window comprises:
in response to a selection of the first media item and at least one third media item of the plurality of media items, adding the first media item and the at least one third media item to the media editing window.

6. The method of claim 1, wherein the input information is the first input information, and the method further comprises:
displaying an added fourth media item in the media editing window, and the fourth media item is determined based on second input information, the second input information being different from the first input information; and
in response to a selection of the fourth media item, replacing the fourth media item with a fifth media item corresponding to the second input information.

7. The method of claim 1, further comprising:
posting a media content item comprising the replaced second media item.

8. The method of claim 7, wherein the plurality of media items are generated by a model based on the input information.

9. The method of claim 8, wherein a playback interface of the media content item is configured to present an indication element in association with the second media item, the indication element indicating that the second media item is generated by the model, and the indication element is configured to direct to an item generation panel, and the item generation panel is configured to provide a media item generated based on received input information.

10. A method of inputting a media item, comprising:
receiving input information of a user;
determining a plurality of media items based on the input information;
receiving a selection instruction for a first media item of the plurality of media items;
adding the first media item in a media editing window;
receiving at least one predetermined operation instruction for the first media item; and
replacing the first media item in the media editing window with a second media item of the plurality of media items.

11. The method of claim 10, wherein replacing the first media item in the media editing window with the second media item of the plurality of media items comprises:
receiving a selection instruction for the first media item;
determining at least one further media item of the plurality of media items;
receiving a selection instruction for the second media item of the at least one further media item; and
replacing the first media item in the media editing window with the second media item.

12. The method of claim 11, wherein determining the at least one further media item of the plurality of media items comprises:
receiving a selection instruction for the first media item;
receiving a selection instruction for a replacement entry provided based on the selection instruction; and
determining the at least one further media item of the plurality of media items.

13. The method of claim 10, wherein adding the first media item in the media editing window comprises:
receiving a selection instruction for the first media item and at least one third media item of the plurality of media items; and
adding the first media item and the at least one third media item to the media editing window.

14. The method of claim 10, wherein the input information is first input information, and the method further comprises:
providing an added fourth media item in the media editing window, and the fourth media item is determined based on second input information, the second input information being different from the first input information;
receiving a selection instruction for the fourth media item; and
replacing the fourth media item with a fifth media item corresponding to the second input information.

15. The method of claim 10, further comprising:
posting a media content item comprising the replaced second media item.

16. The method of claim 15, wherein the plurality of media items are generated by a model based on the input information.

17. The method of claim 16, wherein a playback interface of the media content item is configured to present an indication element in association with the second media item, the indication element indicating that the second media item is generated by the model, and the indication element is configured to direct to an item generation panel, and the item generation panel is configured to provide a media item generated based on received input information.

18. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
presenting a plurality of media items based on input information of a user, and the plurality of media items are determined based on the input information;
adding a first media item in a media editing window in response to a selection of the first media item of the plurality of media items; and
in response to at least one predetermined operation for the first media item, replacing the first media item in the media editing window with a second media item of the plurality of media items.

19. The electronic device of claim 18, wherein in response to at least one predetermined operation for the first media item, replacing the first media item in the media editing window with the second media item of the plurality of media items comprises:
in response to triggering the first media item, presenting at least one further media item of the plurality of media items; and
in response to a selection of the second media item of the at least one further media item, replacing the first media item in the media editing window with the second media item.

20. The electronic device of claim 19, wherein presenting the at least one further media item of the plurality of media items comprises:
presenting a replacement entry in response to the triggering of the first media item; and
in response to a selection of the replacement entry, presenting the at least one further media item of the plurality of media items.
